(19) United States
(12) Patent Application Publication
(10) Pub. No.: US 2010/0332551 A1
(43) Pub. Date: Dec. 30, 2010

(54) Multi-Tiered Caching Architecture For Systems Management

(75) Inventors: Mark A. Collins, Dripping Springs, TX (US); Manoj Gujarathi, Round Rock, TX (US); Ravi D. Kumar, Austin, TX (US); Donald R. Saathoff, JR., Rollingwood, TX (US)

Correspondence Address: HAMILTON & TERRILE, LLP, P.O. BOX 203518, AUSTIN, TX, 78720, US

(73) Assignee: DELL PRODUCTS L.P.

(21) Appl. No.: 12/493,853

(22) Filed: Jun. 29, 2009

(51) Int. Cl. G06F 17/30; G06F 15/173

(52) U.S. Cl. 707/802; 709/223; 707/803; 707/912; 707/955; 707/805; 707/770

(57) ABSTRACT

A surrogate systems management system with enables the creation of a potential full suite of systems management functionality via a proxy environment. The surrogate systems management system thus enables virtual creation of management abilities in a managed services environment without the need for creation of managed service specific agentry and consoles. Such a surrogate systems management system leverages onsite, within the firewall, services appliance to virtually host vendor provided management consoles and leverage the analytics intelligence of the services appliance to create correlating metadata tying the consoles to the respective vendor provided management mechanism (which may or may not include an agent).

### BACKGROUND OF THE INVENTION

1. Field of the Invention

The present invention relates to information handling systems and more particularly to a multi-tiered caching architecture for systems management.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity). The entity that services and supports such an installation is often referred to as a managed service provider. Managed services, or life-cycle services, generally include deployment services and asset services. More specifically, managed services include some or all of asset deployment and installation services, asset management services (including, e.g., both asset tracking and asset moving services), asset maintenance services and asset retirement services.

A managed service provider provides a customer with an ability to procure, deploy, support and manage information handling system technologies across the life cycle of the information handling systems. Issues relating to managed services include information management and asset utilization while providing quality service delivery and a favorable customer experience.

An issue in a managed services environment relates to not having access to the software and service application images that may be required for an on demand needs. This issue can lead to breaking of a service level agreement or to performance issues. Additionally, moving these images or applications from one database (e.g., a database outside of the managed systems' firewall) to an on site cache can exacerbate this issue. In the services arena, there is a strong need to provide a multi-tiered caching of software images.

### SUMMARY OF THE INVENTION

In accordance with the present invention, a systems management environment includes multi-tiered caching thus enabling the environment to provide on demand staging of software and service applications via hierarchical tiered storage. By providing the systems management environment with multi-tiered caching, multiple software images (e.g., for heterogeneous hardware vendors) may be staged and tiered on demand to cater to the on premise service needs of the managed system. The software images can include vendor specific basic input output system (BIOS), firmware (FW), drivers as well as services applications such as SQL services applications, Exchange services applications, Oracle services applications, etc.

Additionally, in certain embodiments, the managed systems can include server type information handling systems which include managed persistent storage. This managed persistent storage can provide one of the tiers (e.g., the last tier) of the caching thus offering a fast deployment of the image associated close to the server information handling system. Additionally, in certain embodiments, the environment can include a network operations center which creates a two tiered caching tiers based on a tie in to an offering (ITaaS vs. SaaS). The on premise agent appliance, collects an inventory of all the hardware, software and service applications components. This inventory is stored as meta data in linked but discreet catalogs, which can stage selective caching associated with inventory in the services cache. This cache can be tiered further to the managed persistent storage if available for on demand scaling and deployment.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a surrogate managed services system environment.

FIG. 2 shows a block diagram of an inventory catalog and collection module of the multi-tiered caching.

FIG. 3 shows a flow chart of the operation of a multi-tiered caching system.

FIG. 4 shows a block diagram of an information handling system.

### DETAILED DESCRIPTION

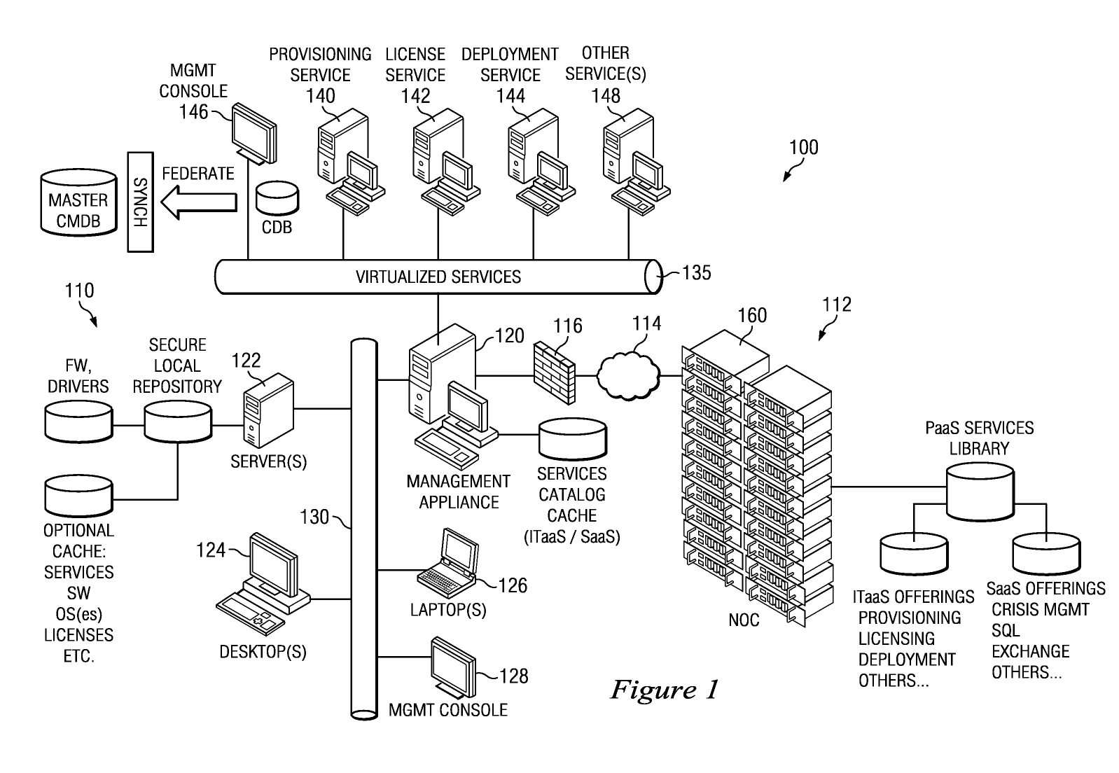

Referring to FIG. 1, a block diagram of a managed services system environment 100 is shown. More specifically, the managed services system environment includes a customer portion 110 as well as a service provider portion 112 coupled via a network 114 (such as the Internet) and a firewall 116.

The customer portion 110 includes a management appliance 120. The customer portion further includes a plurality of information handling systems including servers 122, desktops 124 and laptops 126. The customer portion further includes a management console 128. The information handling systems and the management console are coupled via one or more busses 130. The servers 122 can include an embedded systems management capability having a persistent storage capability. For example, the server 122 can include a secure local repository for firmware and drivers as well as an optional cache in which services, software, operating systems and licenses are stored.

The management console 120 provides the managed services system environment 100 with a plurality of virtualized services 135. More specifically, the management console 120 provides a provisioning services 140, a license service 142, a deployment service 144 as well as a management console 146 (such as an Open Manage Console or an OpenView Console) and other services 148. It will be appreciated that in certain customer portions, the management console 120 may be included within a server 122 and thus the virtualized services 140 would be provided via a server 122.

The service provider portion 112 includes a network operations center 160. The NOC 160 enables the service provider to provide a dynamically tiered services library, such as providing a Platform as a service (PaaS) Services Library as well as information technology as a service (ITaaS) offerings and software as a service (SaaS) offerings. By providing the surrogate managed services system, the service provider portion 112 can provide the virtualized services as a subscription type service or as a one time service. For particular customers, certain services (such as the provisioning service) might be better provided as a one time service rather than a subscription based service. Additionally, the provision of certain services may change from a one time service to a subscription based service due to a change in the customer environment. The surrogate managed services system enables an ongoing inventory of the customer portion 110 of the environment to be easily and continually (if desired) performed. Accordingly, using the surrogate managed services system to provide virtualized services, a service that may have been traditionally considered an ITaaS offering can actually be provided to a customer as a SaaS offering.

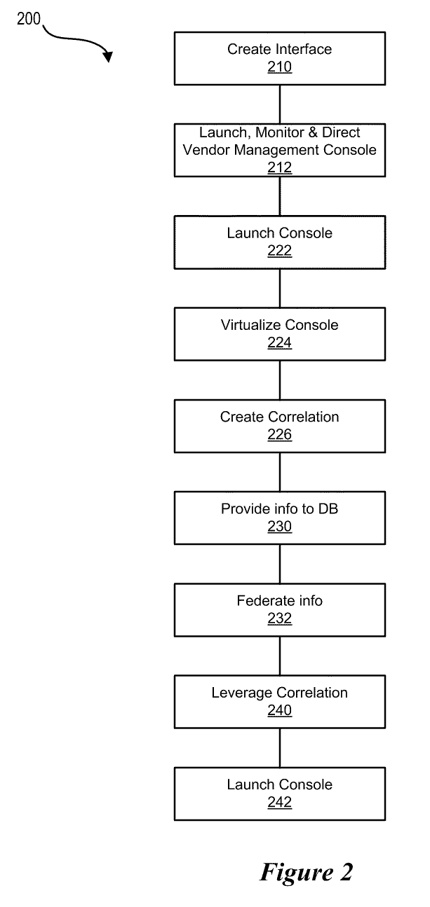

FIG. 2 shows a block diagram of an inventory catalog and collection module of the multi-tiered caching.

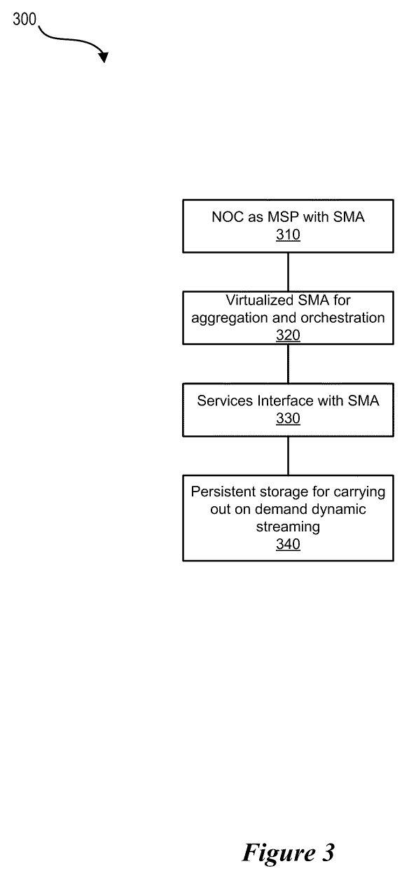

FIG. 3 shows a flow chart of the operation of a multi-tiered caching system.

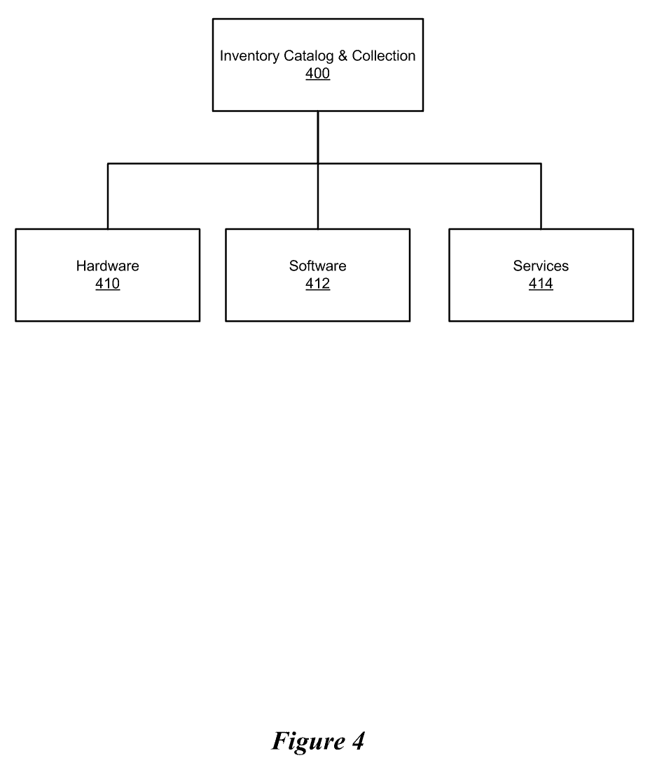

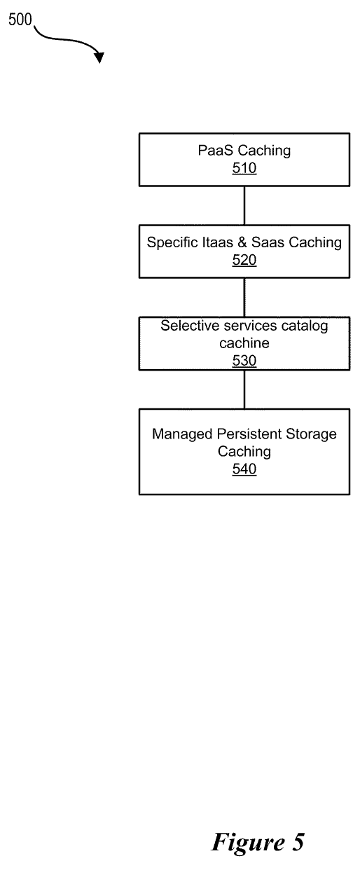

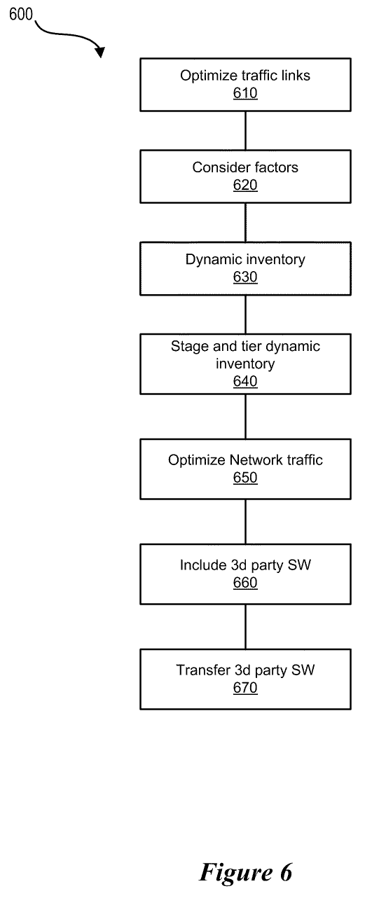

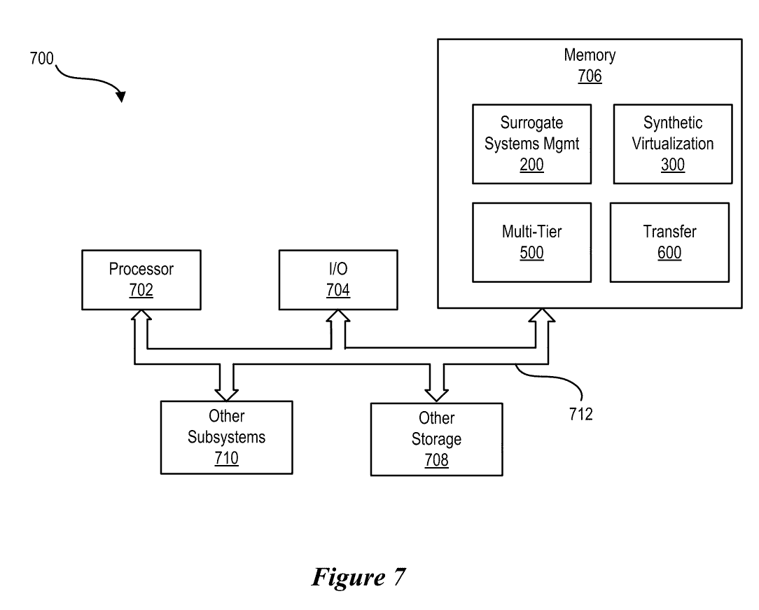

Referring briefly to FIG. 4, a system block diagram of an information handling system 400 is shown. The information handling system 400 may include for example a server 122 or a management appliance 120.

The information handling system 400 includes a processor 402, input/output (I/O) devices 404, such as a display, a keyboard, a mouse, and associated controllers (each of which may be coupled remotely to the information handling system 400), a memory 406 including volatile memory such as random access memory (RAM) and non-volatile memory such as a hard disk and drive, and other storage devices 408, such as an optical disk and drive and other memory devices, and various other subsystems 410, all interconnected via one or more buses 412.

The information handling system 400 can further include the surrogate systems management system 200 stored on its memory 106 for execution by its processor 102. The information handling system 400 can further include a synthetic virtualization system 300 stored on its memory 106 for execution by its processor 102. The information handling system 400 can further include an embedded systems management system having persistent storage capability.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably, or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for performing heterogeneous systems management comprising:
providing a surrogate systems management system, the surrogate systems management system enabling creation of a suite of systems management functionality via a proxy environment;
leveraging an onsite, within a firewall, services appliance to virtually host a vendor provided management console; and,
leveraging analytics intelligence of the services appliance to create correlating metadata tying the vendor provided management console to a respective vendor provided management mechanism.

2. The method of claim 1 wherein:
the surrogate systems management system is extended to create an interface console.

3. The method of claim 2 wherein:
the respective vendor management console can be launched, monitored and directed to carry out the administrative functions.

4. The method of claim 1 wherein:
an operator managing services operations can launch the console remotely, the vendor provided management console being virtualized on the services appliance.

5. The method of claim 1 wherein:
the surrogate systems management system provides a dynamically tiered services library, the dynamically tiered services library comprising an inventory collection and dynamic analytics portion, the inventory collection and dynamic analytics portion of the surrogate systems management system creating a correlation between a vendor system and systems management offering

6. The method of claim 5 wherein:
the correlation comprises a name value pair.

7. The method of claim 5 wherein:
the correlation information is provided to a configuration database (CBD) for respective virtual environments executing on the vendor console; and,
the configuration databases for the respective virtual environments are federated into a master configuration management database (CMDB), the master configuration management database providing a single source of truth having knowledge of an entire managed services environment

8. An apparatus for performing heterogeneous systems management comprising:
a surrogate systems management system, the surrogate systems management system enabling creation of a suite of systems management functionality via a proxy environment;
a services appliance located onsite, within a firewall, the services appliance being leveraged to virtually host a vendor provided management console, the services appliance comprising analytics intelligence, the surrogate systems management system leveraging the analytics intelligence of the services appliance to create correlating metadata tying the vendor provided management console to a respective vendor provided management mechanism.

9. The apparatus of claim 8 wherein:
the surrogate systems management system is extended to create an interface console.

10. The apparatus of claim 9 wherein:
the vendor management console can be launched, monitored and directed to carry out the administrative functions.

11. The apparatus of claim 8 wherein:
an operator managing services operations can launch the console remotely, the vendor provided management console being virtualized on the services appliance.

12. The apparatus of claim 8 wherein:
the surrogate systems management system provides a dynamically tiered services library, the dynamically tiered services library comprising an inventory collection and dynamic analytics portion, the inventory collection and dynamic analytics portion of the surrogate systems management system creating a correlation between a vendor system and systems management offering

13. The apparatus of claim 12 wherein:
the correlation comprises a name value pair.

14. The apparatus of claim 12 wherein:
the correlation information is provided to a configuration database (CBD) for respective virtual environments executing on the vendor console; and,
the configuration databases for the respective virtual environments are federated into a master configuration management database (CMDB), the master configuration management database providing a single source of truth having knowledge of an entire managed services environment

15. A method for performing systems management comprising:
providing a information handling system with an embedded systems management capability having a persistent storage capability;
providing a synthetic virtualization system;
using the synthetic virtualization system to provide the information handling system having the embedded system management capability with virtualization like capabilities.

16. The method of claim 15 further comprising:
storing multiple customer system images within the embedded systems management capability having the persistent storage capability.
provide an ability to stage multiple customer system images so as to provide an illusion that the system is switching and loading on demand or a t predetermined intervals between multiple images.

17. The method of claim 16 further comprising:
staging the multiple customer system images so as to provide an illusion that the system is switching and loading on demand or at predetermined intervals between the multiple customer system images.

18. The method of claim 15 wherein:
an operator managing services operations can launch a management console remotely, the management console being virtualized on the services appliance.

19. The method of claim 15 wherein:
the synthetic virtualization system provides a dynamically tiered services library, the dynamically tiered services library comprising an inventory collection and dynamic analytics portion, the inventory collection and dynamic analytics portion of the synthetic virtualization system creating a correlation between a vendor system and a systems management offering

20. The method of claim 15 wherein:
the synthetic virtualization system enables a service provider to deliver information technology as a service (ITaaS) as a software as a service (SaaS) offering and SasS as an ITaaS offering.
